(19) United States
(12) Patent Application Publication
(10) Pub. No.: US 2001/0026269 A1
(43) Pub. Date: Oct. 4, 2001

(54) Display controller and information processor having a display controller

(75) Inventor: Akihiko Sano, Ome-shi (JP)

Correspondence Address: Finnegan, Henderson, Farabow, Garrett & Dunner, L.L.P., 1300 I Street, N.W., Washington, DC, 20005-3315, US

(73) Assignee: Kabushiki Kaisha Toshiba

(21) Appl. No.: 09/781,416

(22) Filed: Feb. 13, 2001

(30) Foreign Application Priority Data
Mar. 30, 2000 (JP) 2000-094553

(51) Int. Cl. G09G 5/00

(52) U.S. Cl. 345/204

(57) ABSTRACT

When interlace image data is to be displayed on an interlace display unit, the input interlace image data is output as interlace data to a display unit via a VRAM and television signal generator.

### CROSS-REFERENCE TO RELATED APPLICATIONS

This application is based upon and claims the benefit of priority from the prior Japanese Patent Application No. 2000-094553, filed Mar. 30, 2000, the entire contents of which are incorporated herein by reference.

### BACKGROUND OF THE INVENTION

The recent spread of information processors is remarkable in any field. In particular, high-speed processing of image data which is conventionally difficult to achieve can be done with improvements of the capabilities of information processors. Accordingly, so-called multimedia fields including processing of image data are rapidly progressing. As a device for displaying such image data, devices such as a CRT, LCD, plasma display, and television set are used.

An interlace system is one display system for displaying image data on these display devices and used in devices such as a television set. In this system, 525 scanning lines are formed on the display screen of a display device. For the first 1/60 sec, a half of all scanning lines, e.g., 262.5 scanning lines are scanned. The portion thus scanned is a first field. For the next 1/60 sec., the remaining 262.5 scanning lines are scanned so as to bury spaces between the scanning lines in the first field. The portion thus scanned is a second field. One complete image can be obtained by combining these first and second fields. This complete image is called a frame. Also, image data obtained by this interlace system is called interlace data.

A noninterlace system is another image data display system. This system is used in display devices such as a CRT and LCD. In this system, all 525 scanning lines on the display screen are sequentially scanned to complete an image. Image data obtained by the noninterlace system is called noninterlace data.

As described above, these systems are selectively used in accordance with the type of display device. That is, the interlace system is used in television sets, and the noninterlace system is used in a CRT and LCD used as display devices of information processors such as computers.

Accordingly, a display controller for controlling display of a conventional information processor is designed to display images on a CRT or LCD and primarily processes noninterlace image data.

### BRIEF SUMMARY OF THE INVENTION

It is an object of the present invention to provide a display controller capable of outputting image data having suppressed image deterioration to an interlace display unit, and an information processor having this display controller.

According to the present invention, a display controller capable of controlling both interlace image data and noninterlace image data comprises an input terminal for inputting interlace image data, an output terminal for outputting interlace image data, and a connecting circuit for connecting the input and output terminals and transferring interlace image data as interlace image data.

With this arrangement, image data having suppressed image deterioration can be output to a display unit.

Also, the present invention comprises an input unit for inputting encoded image data, a decoding unit for decoding the encoded image data, a display controller for processing the image data decoded by the decoding unit, and an output unit for outputting the image data processed by the display controller to a display unit, wherein the display controller comprises an input terminal for inputting interlace image data, an output terminal for outputting interlace image data, and a connecting circuit for connecting the input and output terminals and transferring interlace image data as interlace image data.

With this arrangement, image data having suppressed image deterioration can be displayed.

Furthermore, the present invention comprises an input terminal for inputting interlace image data, a first output terminal for outputting interlace image data, a connecting circuit for connecting the input terminal and the first output terminal and transferring interlace image data as interlace image data, a converter for converting the input interlace image data from the input terminal into noninterlace image data, and a second output terminal for outputting the noninterlace image data obtained by the converter.

With this arrangement, image data having suppressed image deterioration can be displayed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the display system configuration of an information processor according to the first embodiment of the present invention; and

FIG. 2 is a block diagram showing the display system configuration of an information processor according to the second embodiment of the present invention.

### DETAILED DESCRIPTION OF THE INVENTION

Embodiments of the present invention will be described below with reference to the accompanying drawings.

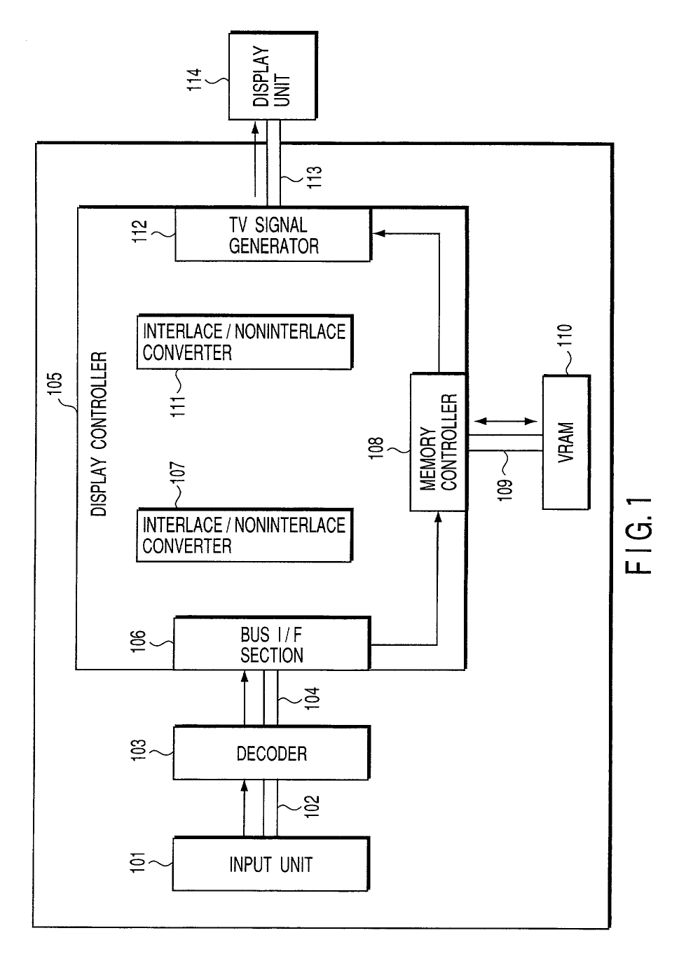

The first embodiment will be described below with reference to FIG. 1. FIG. 1 is a block diagram showing the arrangement of a display controller of a computer system. Components pertaining to processing of interlace image data will be primarily explained below. The arrows indicate the flow of interlace image data.

An input unit 101 outputs image data to a decoder 103 via a general-purpose bus 102 (to be described below). This image data is compressed interlace image data. A DVD drive is an example of the input unit 101. The general-purpose bus 102 is a transmission path for transmitting the output image data from the input unit 101 to the decoder 103. A PCI bus is an example of this general-purpose bus 102.

The decoder 103 decodes the image data transmitted via the general-purpose bus 102. This decoded data is interlace image data. The decoder 103 outputs the decoded image data to a bus I/F section 106 in a display controller 105 via a video bus 104 (to be described below). Examples of this decoder 103 are an MPEG decoder and CPU.

The video bus 104 is a transmission path for transmitting the output interlace image data from the decoder 103 to the bus I/F section 106 of the display controller 105. Examples of this video bus are a ZV port, PCI bus, and AGP bus.

The display controller 105 controls display of this information processor. This display controller 105 has two functions: a function of converting the interlace image data from the decoder 103 into noninterlace image data and saving the data in a VRAM 110; and a function of outputting the noninterlace image data saved in the VRAM 110 to a display unit 114. To implement these functions, the display controller 105 contains various circuits (the bus I/F section 106, an interlace/noninterlace converter 107, a memory controller 108, a noninterlace/interlace converter 111, and a television signal generator 112) to be described below. This display controller 105 can, of course, receive noninterlace image data and output noninterlace image data.

The bus I/F section 106 receives the output interlace image data from the decoder 103 and outputs this interlace image data to the memory controller 108.

The memory controller 108 writes the interlace image data received from the bus I/F section 106 into the VRAM (Video Random Access Memory) 110 via a VRAM bus 109. Also, this memory controller 108 reads out the interlace image data written in the VRAM 110 via the VRAM bus 109, and outputs the readout data to the television signal generator 112.

The VRAM bus 109 is a transmission path connecting the memory controller 108 and the VRAM 110. Via this VRAM bus 109, the memory controller 108 writes interlace image data into the VRAM 110 and reads out interlace image data from the VRAM 110.

The VRAM 110 saves the output interlace image data from the memory controller 108 and outputs the interlace image data to the memory controller 108 in accordance with instructions from this memory controller 108.

The television signal generator 112 generates a television signal from the output interlace image data from the memory controller 108, and outputs the signal to the display unit 114 via a television signal line 113.

The television signal line 113 is a transmission path for transmitting the output television signal from the television signal generator 112 to the display unit 114. The display unit 114 is an interlace display unit and displays the output television signal from the television signal generator 112. A television set is an example of this display unit 114.

When noninterlace image data is to be displayed on the interlace display unit in this embodiment, the memory controller 108 writes image data received by the bus I/F section 106 into the VRAM 110 via the VRAM bus 109. Also, this memory controller 108 reads out the image data written in the VRAM 110 and outputs the readout data to the television signal generator 112.

When interlace image data is to be displayed on a noninterlace display unit (not shown), the memory controller 108 sends the interlace image data to the interlace/noninterlace converter 107 which converts this interlace image data into noninterlace image data. The display controller 105 outputs the converted image data to the noninterlace display unit.

When noninterlace image data is to be displayed on a noninterlace display unit (not shown), the memory controller 108 receives the image data from the bus I/F section 106 and outputs this noninterlace image data to the noninterlace display unit via the VRAM bus 109 and the VRAM 110.

With this arrangement, when interlace image data is to be displayed on the interlace display unit, the display controller does not convert the input interlace image data into noninterlace image data. This interlace image data is directly written in and read out from the VRAM. This can suppress deterioration of the image quality.

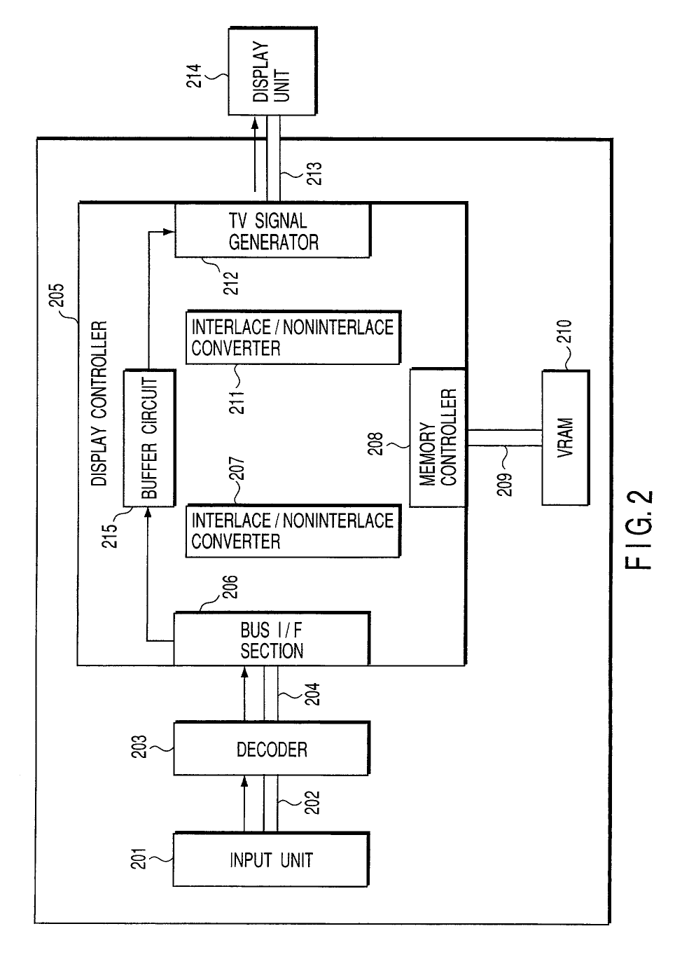

The second embodiment of the present invention will be described below with reference to FIG. 2. This second embodiment is a system which outputs interlace image data to a display unit with no intervention of a VRAM. FIG. 2 is a block diagram showing a display controller of a computer system according to the second embodiment of the present invention. The arrows indicate the flow of interlace image data in this embodiment.

An input unit 201 outputs image data to a decoder 203 via a general-purpose bus 202 (to be described below). This image data is compressed interlace image data. A DVD drive is an example of the input unit 201. The general-purpose bus 202 is a transmission path for transmitting the output image data from the input unit 201 to the decoder 203. A PCI bus is an example of this general-purpose bus 202.

The decoder 203 decodes the image data transmitted via the general-purpose bus 202. This decoded data is interlace image data. The decoder 203 outputs the decoded image data to a bus I/F section 206 in a display controller 205 via a video bus 204 (to be described below). Examples of this decoder 203 are an MPEG decoder and CPU.

The video bus 204 is a transmission path for transmitting the output interlace image data from the decoder 203 to the bus I/F section 206 of the display controller 205. Examples of this video bus are a ZV port, PCI bus, and AGP bus.

The display controller 205 controls display of this information processor. This display controller 205 has two functions: a function of converting the interlace image data from the decoder 203 into noninterlace image data and saving the data in a VRAM 210; and a function of outputting the noninterlace image data saved in the VRAM 210 to an output unit 214. To implement these functions, the display controller 205 contains various circuits (the bus I/F section 206, an interlace/noninterlace converter 207, a memory controller 208, a noninterlace/interlace converter 211, a television signal generator 212, and a buffer circuit 215) to be described below.

The bus I/F section 206 receives the output interlace image data from the decoder 203 and outputs this interlace image data to the buffer circuit 215.

In this embodiment, the memory controller 208 does not contribute to the flow of image data when interlace image data is to be displayed on an interlace display unit. When noninterlace image data is to be displayed on an interlace display unit, the memory controller 208 writes the noninterlace image data received by the bus I/F section 206 into the VRAM 210 via a VRAM bus 209. Also, this memory controller 208 reads out the noninterlace image data written in the VRAM 210 via the VRAM bus 209, and outputs the readout data to the noninterlace/interlace converter 211. The noninterlace/interlace converter 211 converts the noninterlace image data into interlace image data and outputs the converted data to the television signal generator 212.

When interlace image data is to be displayed on a noninterlace display unit (not shown), the bus I/F section 206 sends the image data to the interlace/noninterlace converter 207. The interlace/noninterlace converter 207 converts this interlace image data into noninterlace image data and transmits the converted data to the memory controller 208. The memory controller 208 outputs this noninterlace image data to the noninterlace display unit via the VRAM bus 209 and the VRAM 210.

When noninterlace image data is to be displayed on a noninterlace display unit (not shown), the memory controller 208 receives the image data from the bus I/F section 206 and outputs this noninterlace image data to the noninterlace display unit via the VRAM bus 209 and the VRAM 210.

The buffer circuit 215 outputs interlace image data output from the bus I/F section 206 to the television signal generator 212 in the order in which the data is input. The television signal generator 212 generates a television signal from this output interlace image data from the buffer circuit 215, and outputs the signal to the display unit 214 via a television line 213.

The television signal line 213 is a transmission path for transmitting the output television signal from the television signal generator 212 to the display unit 214. The display unit 214 is an interlace display unit and displays the output television signal from the television signal generator 212. A television set is an example of this display unit 214.

Also in this second embodiment, when interlace image data is to be displayed on the interlace display unit, the display controller does not convert the input interlace image data into noninterlace image data. This interlace image data is directly output from the buffer circuit. This can suppress deterioration of the image quality.

Unlike the first embodiment, this second embodiment has the advantage that interlace image data is not exchanged between the display controller and the VRAM, so time lag is prevented. Also, a system using a buffer circuit like this embodiment is advantageous in processing stream data, such as a motion picture, in which images are supplied in turn.

In each embodiment of the present invention, the VRAM and VRAM bus are shown outside the display controller in each corresponding drawing. However, these VRAM and VRAM bus can also be mounted in the same package as the display controller. When this is the case, it is possible to reduce the cost and mounting area by forming the display controller and VRAM into one chip.

Also, although the television signal generator is shown inside the display controller in each drawing, this generator can also be placed outside the display controller. Either arrangement can be appropriately selected in accordance with the system configuration.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display controller capable of controlling both interlace image data and noninterlace image data, comprising:
an input terminal for inputting interlace image data;
an output terminal for outputting interlace image data; and
a connecting circuit for connecting said input and output terminals and transferring interlace image data as interlace image data.

2. A controller according to claim 1, wherein said connecting circuit comprises a buffer circuit for storing input interlace image data from said input terminal, and image data is output from said buffer circuit to said output terminal.

3. A controller according to claim 1, wherein said display controller is integrated into one chip.

4. A controller according to claim 2, wherein said display controller is integrated into one chip.

5. An information processor comprising:
an input unit for inputting encoded image data;
a decoding unit for decoding the encoded image data;
a display controller for processing the image data decoded by said decoding unit; and
an output unit for outputting the image data processed by said display controller to a display unit,
wherein said display controller comprises
an input terminal for inputting interlace image data,
an output terminal for outputting interlace image data, and
a connecting circuit for connecting said input and output terminals and transferring interlace image data as interlace image data.

6. A processor according to claim 5, wherein said connecting circuit comprises a buffer circuit for storing input interlace image data from said input terminal, and image data is output from said buffer circuit to said output terminal.

7. A processor according to claim 5, further comprising a television signal generator for generating and outputting a television signal from the image data processed by said display controller.

8. A processor according to claim 6, further comprising a television signal generator for generating and outputting a television signal from the image data processed by said display controller.

9. A display controller comprising:
an input terminal for inputting interlace image data;
a first output terminal for outputting interlace image data;
a connecting circuit for connecting said input terminal and said first output terminal and transferring interlace image data as interlace image data;
a converter for converting the input interlace image data from said input terminal into noninterlace image data; and
a second output terminal for outputting the noninterlace image data obtained by said converter.

10. A controller according to claim 9, wherein said display controller is integrated into one chip.
